(19) United States
(12) Patent Application Publication
(10) Pub. No.: US 2023/0182647 A1
(43) Pub. Date: Jun. 15, 2023

(54) FIREARM HOLDER FOR VEHICLES

(71) Applicant: Hunter Larson, St. George, UT (US)

(72) Inventor: Hunter Larson, St. George, UT (US)

(21) Appl. No.: 18/064,602

(22) Filed: Dec. 12, 2022

Related U.S. Application Data
(60) Provisional application No. 63/288,270, filed on Dec. 10, 2021.

(51) Int. Cl. B60R 7/14

(52) U.S. Cl. CPC B60R 7/14

(57) ABSTRACT

A firearm holder features a leg having a non-abrasive coating coupled to a U-shaped bracket, wherein the leg is interposable between the seats of a vehicle and the bracket is configured to receive the stock of a firearm. In some examples, the bracket includes an adjustable arm opposite a fixed arm configured to vary the width of the bracket to accommodate a variety of models and sizes of stocks. The firearm holder may also feature a strap used to secure the firearm within the bracket, a cable lock configured to immobilize the trigger or receiver of the firearm, and a base member configured to stabilize the firearm holder.

### CROSS-REFERENCE TO RELATED APPLICATIONS

This application claims the benefit of U.S. Provisional Application Ser. No. 63/288,270, filed on Dec. 10, 2021, which is incorporated herein by reference.

### TECHNICAL FIELD

The present disclosure relates to transporting firearms. More particularly, the present disclosure relates to an apparatus for securing a firearm, such as a rifle or shotgun, in a vehicle during transport.

### BACKGROUND

Firearms such as rifles and shotguns are regularly transported in the cab of a truck or passenger area of a car. To aid with safety, firearms should be secured during transport. The most common method to secure a shotgun or rifle in a vehicle is with a gun rack. These racks are typically mounted in a back window or on the back of a seat. While these methods are safe and convenient for transport, they impede quick access to the firearm. For example, there are many circumstances where quick access to a firearm is desirable, such as hunting or law enforcement. However, on many occasions, a user must exit the vehicle to properly access the stowed firearm.

In addition, these racks often require physical modifications to the vehicle, such as the addition of screws that are drilled into the vehicle, creating permanent damage. Other racks obstruct the back seat and prevent the seat from changing position (e.g., sliding forward or backward or altering the angle) or interfere with passengers in the back seat.

Accordingly, there is a need for a firearm holder that does not require modification to the vehicle, permits a user to adjust the seat, enables quick access to the firearm, and that conforms to the stock of a wide variety of rifles and shotguns. The present disclosure solves these problems and others.

### SUMMARY OF EXAMPLE EMBODIMENTS

In some embodiments, a firearm holder comprises a leg and a bracket, the leg interposable between seats and the bracket configured to receive the stock of a firearm. The bracket may be U-shaped and sized so as to receive any one of a variety of stocks. In some embodiments, the bracket comprises an adjustable arm so as to vary the width to fit a variety of stocks. In some embodiments, a strap or band may further be used to secure the firearm in the bracket.

In some methods of use, a user inserts the leg between two seats or between a seat and a console, with the bracket at the top thereof remaining exposed. A user may then place a firearm stock within the bracket, with the barrel resting on the seat and/or the floor. The user may also position the barrel of the firearm within a floor barrel bracket. As a result, the firearm is cradled and prevented from sliding around while remaining accessible to the driver and/or passenger.

### BRIEF DESCRIPTION OF THE DRAWINGS

FIG. 1 illustrates a side perspective view of a firearm holder positioned between seats and securing a firearm;

FIG. 2 illustrates a top perspective view of a firearm holder positioned between seats;

FIG. 3 illustrates a left side perspective view of a firearm holder;

FIG. 4 illustrates a right side perspective view of a firearm holder;

FIG. 5 illustrates a side perspective view of a firearm holder positioned between a seat and a console, securing a firearm;

FIG. 6 illustrates a side perspective view of a firearm holder positioned between a seat and a console, securing a firearm;

FIG. 7 illustrates a side perspective view of a firearm holder positioned between a seat and a console, securing a firearm;

FIG. 8 illustrates a side perspective view of a firearm holder positioned between rear seats and securing a firearm with a scope;

FIG. 9 illustrates a right side perspective view of a firearm holder; and

FIG. 10 illustrates a right side perspective view of a firearm holder.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As discussed earlier, there is a need for a firearm holder that may be installed without permanent modification to the vehicle, that allows a user to adjust his or her seat, that enables ready access to the firearm, and that accommodates a variety of rifles and shotguns. The firearm holder disclosed herein seeks to solve these and other problems.

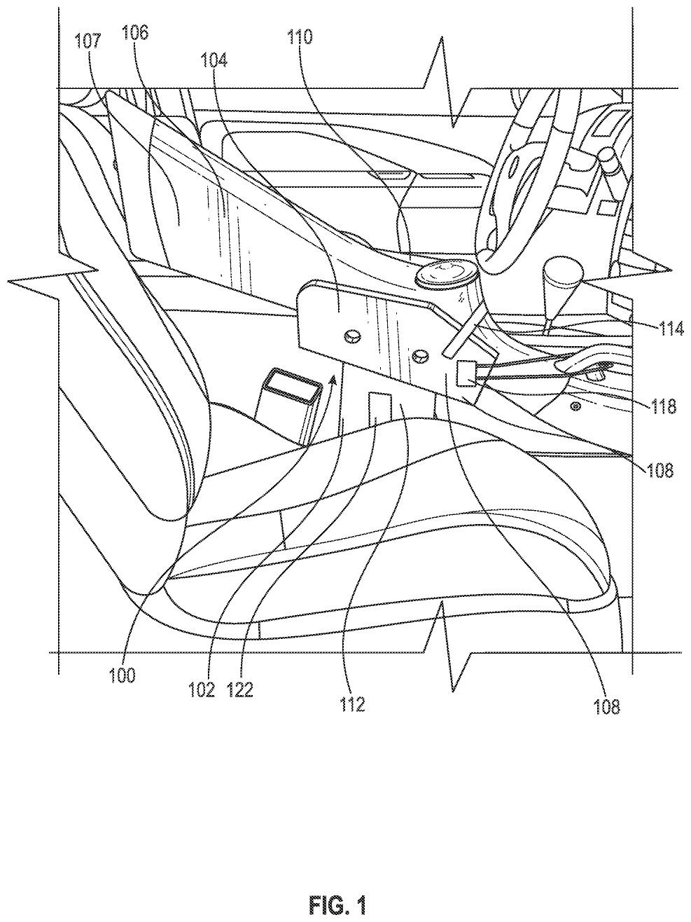

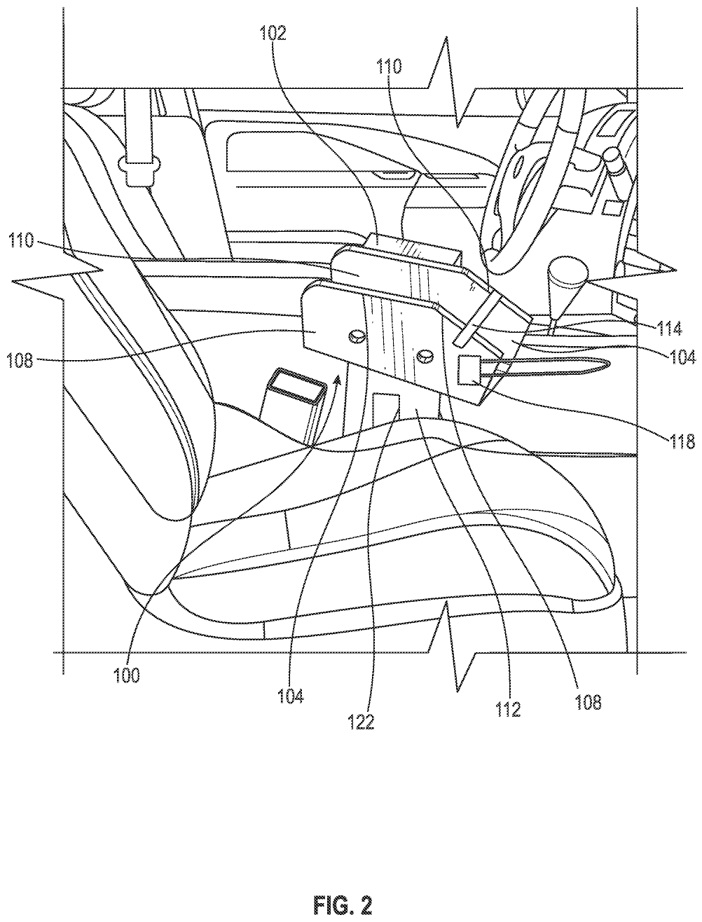

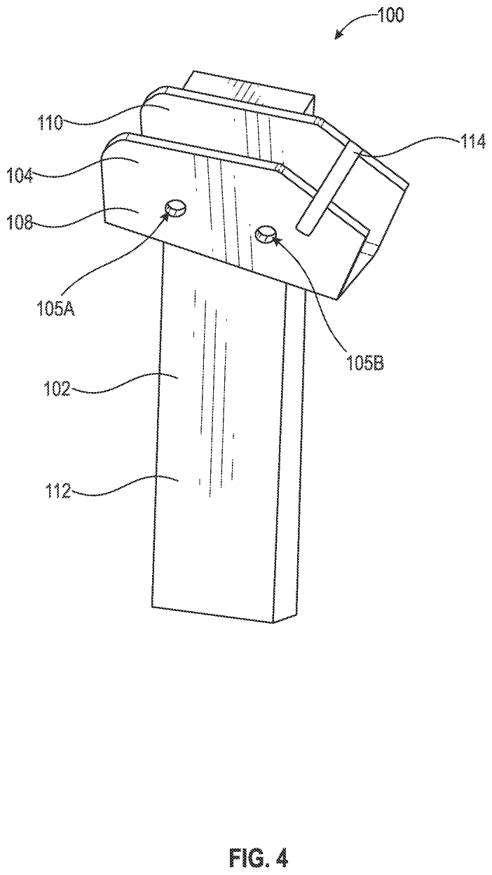

Referring to FIGS. 1-4, in some embodiments, a firearm holder 100 comprises a leg 102 and a bracket 104, the leg 102 being interposable between two vehicle seats and the bracket 104 configured to receive the stock 106 of a firearm 107 (e.g., rifle, shotgun, etc.). The bracket 104 may be U-shaped and sized so as to receive any one of a variety of stocks 106 with varying widths. In some embodiments, the bracket 104 comprises a first adjustable arm 108 opposite a second fixed arm 110 so as to vary the width of the bracket 104 to accommodate a variety of makes and models of forearms having stocks 106 with differing shapes and sizes. Any known clamping methods may be used to effectuate the clamping of the first and second arms 108, 110 on the stock 106, such as threaded bolts, rods and springs, etc. In other embodiments, spring-loaded protrusions or bushings may be used inside the bracket 104 so as to dynamically adjust to stocks 106 of different widths. In some embodiments, as best seen in FIG. 4, one or more apertures 105A, 105B allow for thumb screws or other mechanisms to pass through to place pressure on the stock of a gun, thereby clamping the stock in place within the bracket 104. While not required, this may help avoid unwanted movement of the gun during transport while also accommodating variously-sized stocks.

In some embodiments, a strap 114 or band may further be used to secure the firearm 107 within the bracket 104. For example, the strap 114 may be coupled to the fixed arm 110, pass over the stock 106, and then be coupled to the adjustable arm 108. The strap 114 may comprise a button and clasp, hook and loop closure, magnets, or other know fastening mechanisms. In some embodiments, the firearm holder 100 may comprise a cable lock 118. The cable lock 118 may be positioned through the receiver of the firearm or through the trigger guard providing an added safety measure around younger passengers or to aid in theft deterrent, and may also act as a safeguard against accidental discharge by immobilizing the receiver or trigger.

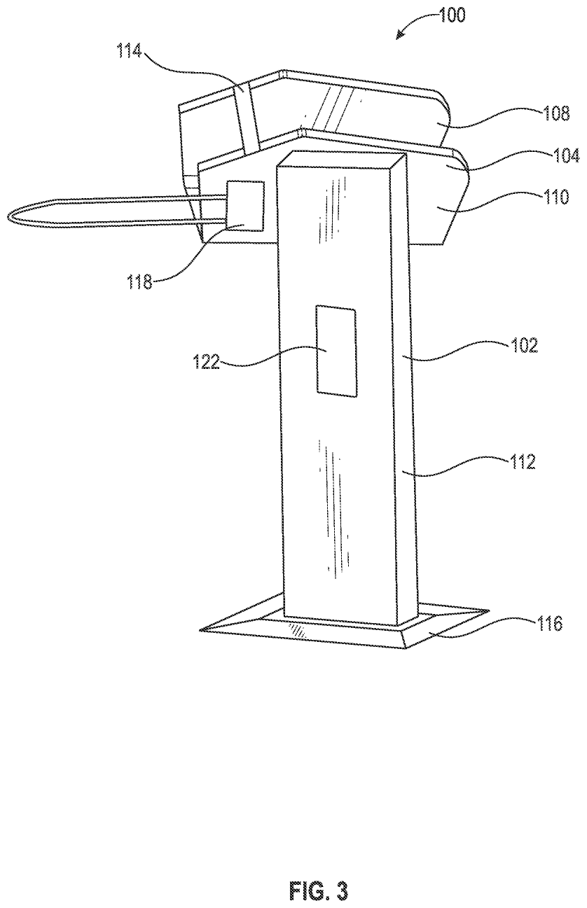

In some embodiments, as seen in FIG. 3, the leg 102 may further comprise a base member 116. The base member 116 may comprise one or more feet, or a lip that circumscribes the leg 102 and radiates outwards to provide additional stability and grounding to the floor of the vehicle. In some embodiments, the base member 116 may comprise screw or bolt apertures, allowing the base member 116 to be securely fastened to the body of the vehicle. This ensures that the firearm holder 100 does not move during transport or use. Additionally, if used in combination with a cable lock 118, the firearm holder 100 deters theft of any firearm in the firearm holder 100.

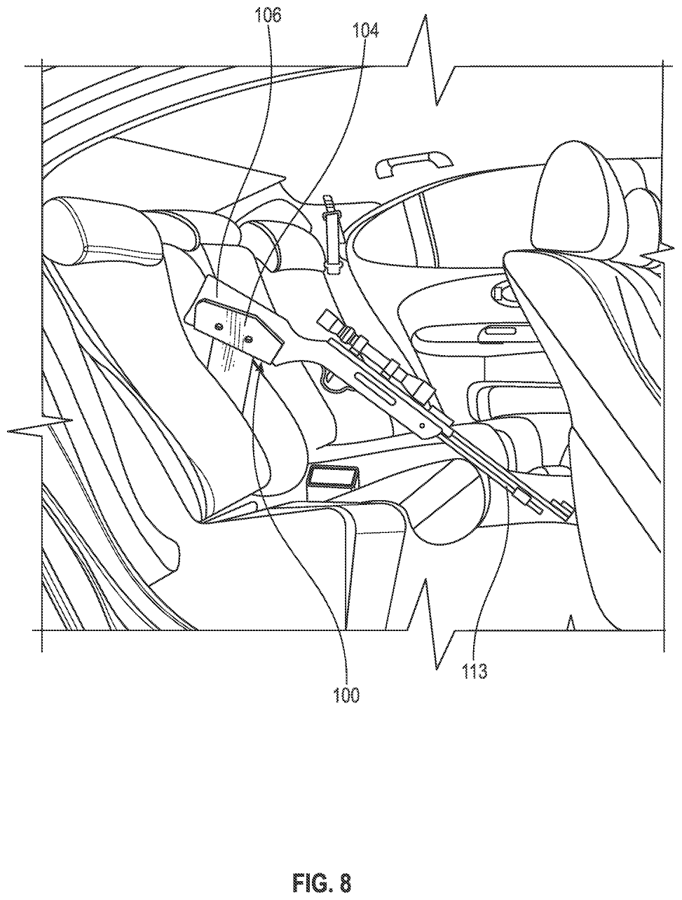

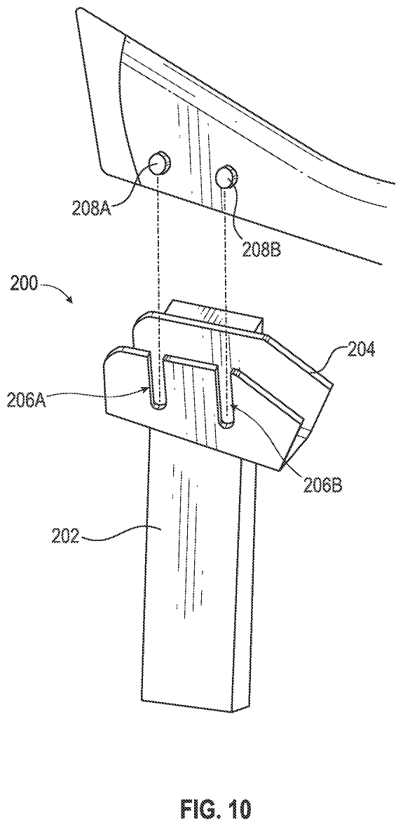

It will be appreciated that the leg 102 and bracket 104 may be made from a variety of materials, including woods, plastics, metals, carbon fibers, any other suitable material, or combinations thereof. Referring to FIGS. 8-12, the leg 102 may comprise a soft, non-abrasive coating 112 configured to prevent aesthetic damages from scrapes or scratches when inserting the leg 102 between seats and or the console. The non-abrasive coating 112 may be a spray-on finish comprising silicones, epoxies, polyurethanes or the like. Alternatively, the non-abrasive coating 112 may comprise a material or fabric such as felt, bamboo fiber, cotton, rayon, polyester, wool, similar materials, or combinations thereof. It will be appreciated that the non-abrasive coating 112 will protect leather interiors and vehicle fixtures such as seat belt bases from aesthetic damage when inserting the leg 102 into position within the vehicle.

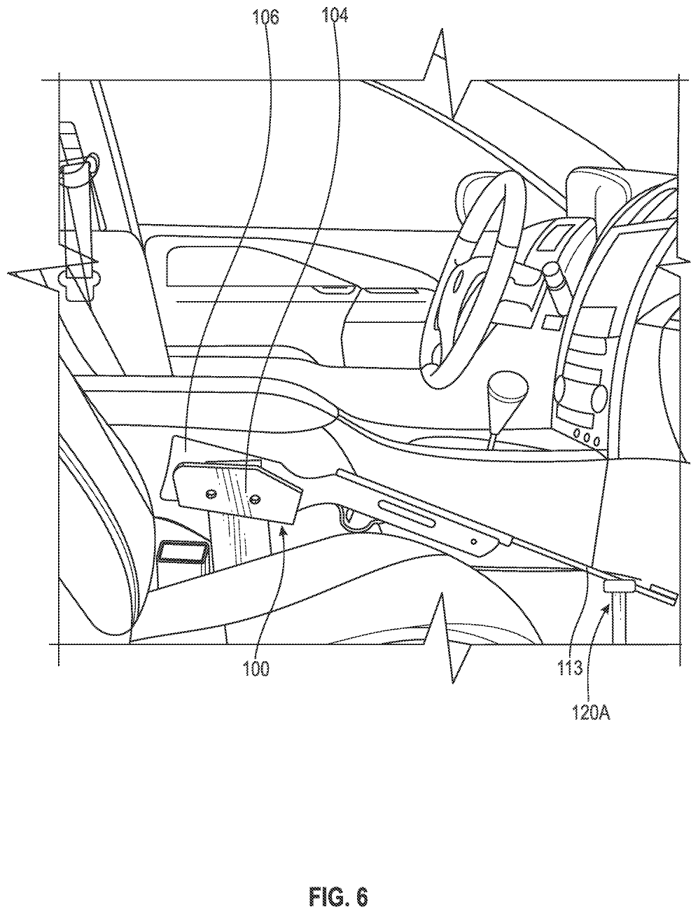

Additionally, the leg 102 may be of sufficient length so as to be interposed between two seats without dislodging therefrom unless a user applies a pulling force. In some embodiments, the leg 102 is long enough to pass between the seats and contact the floor while leaving the bracket 104 exposed (i.e., not below the surface of the seats). In some embodiments, as shown in FIG. 6, a firearm holder 100 further comprises a floor barrel bracket 120A for supporting the barrel 113. In some embodiments, the floor barrel bracket 120A may be couplable to the muzzle to obstruct and secure the opening. The floor barrel bracket 120A may be weighted and comprise a textured base configured to grip the floor of the vehicle without sliding or moving around while the vehicle is in motion. An adhesive, hook and loop fastener, bolts, or other means may be employed to more securely mount the floor barrel bracket 120A to the floor of the vehicle. The barrel bracket 120A may comprise a barrel cradle 121 and a leg 123 for resting on the floor of the vehicle. The barrel cradle 121 may be U-shaped, semi-circular to complement the barrel, or any other suitable shape for supporting the barrel.

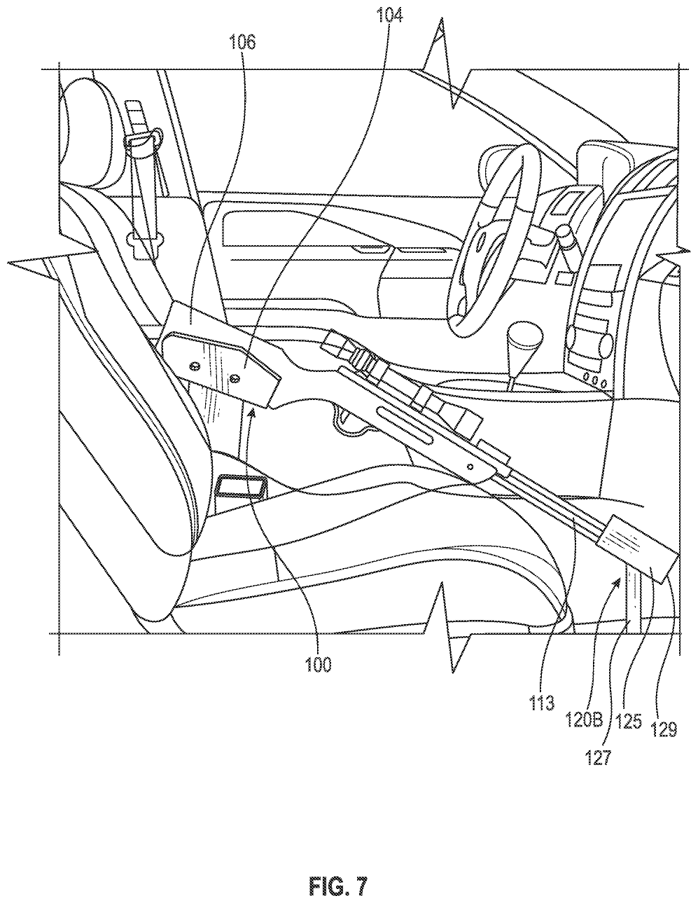

Referring to FIG. 7, in some embodiments, a floor barrel bracket 120B comprises a barrel sleeve 125 for receiving the barrel 113. The barrel sleeve 125 may be cylindrical to complement the shape of a barrel 113. The barrel sleeve 125 may be made from any suitable material, such as aluminum, plastic, etc. In some embodiments, the barrel sleeve 125 may be interchangeable on a base 127 to accommodate different sizes of barrels 113. This allows a base 127 to remain secured to the floor (e.g., bolted, magnetized, etc.) of a vehicle while easily swapping the barrel sleeve 125 to accommodate a user-selected firearm. Additionally, the barrel sleeve 125 may be closed at the base end 129 to keep the muzzle free of debris while ensuring it is secured. The interior of the sleeve may comprise felt or other non-abrasive surfaces so as to not scratch or otherwise damage the barrel 113.

In some embodiments, a magnet 122 (best seen in FIGS. 1-3) may be coupled firstly to the leg 102 of the firearm holder 100 and secondly to a side of the seat or console, thereby further securing the firearm holder 100 in place. As a result, it will be appreciated that there are several embodiments where no vehicle modifications are needed to use the firearm holder 100. Additionally, the seat positioning may be adjusted forwards and backwards, the seatbelt clipped in and out, or the console opened and closed, without disturbing the firearm 107. As a result, the firearm holder 100 overcomes the problems in the prior art.

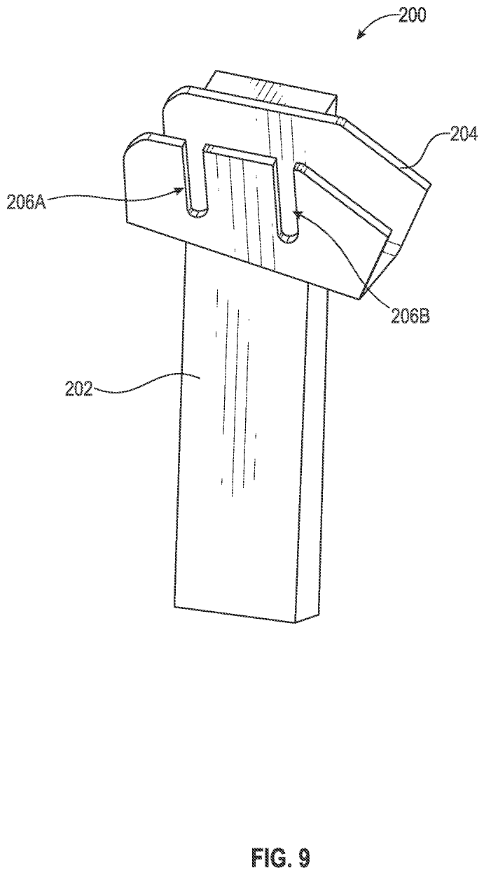

In some embodiments, as shown in FIG. 9, a firearm holder 200 comprises a leg 202 and a bracket 204, wherein the bracket comprises one or more channels 206A, 206B for receiving one or more stock protrusions 208A, 208B, respectively. The stock protrusions 208A, 20B may be retrofitted to any stock by screwing into the stock, by using adhesives, or by using straps. This aids in preventing the firearm from moving during transport. It will be appreciated that straps and other mechanisms may also be used to better secure the firearm, although no additional securing mechanisms are required.

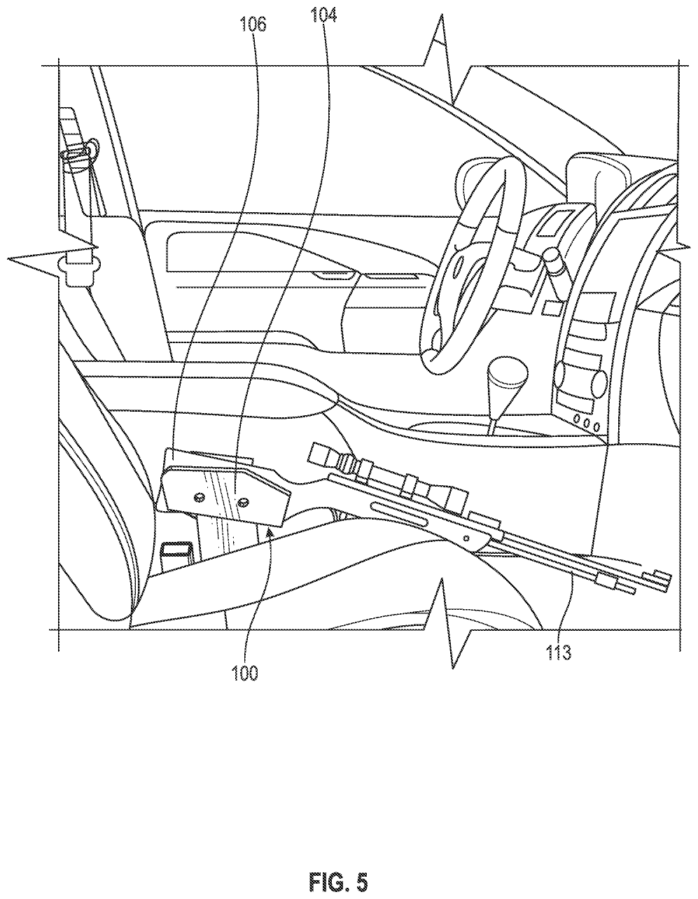

In some methods of use, a user would wedge the leg 102 between two seats, a seat and a center console, or a seat and a door, with the bracket 104 at the top thereof remaining exposed. Because the leg 102 is wedged, it is held in place without modifications to the vehicle. As shown in FIGS. 5-8, a user may then place a firearm stock 106 in the bracket 104, with a barrel resting on the seat and/or the floor, or remaining elevated therefrom. In some embodiments, the adjustable arm 108 may slide or move opposite the fixed arm 110 to accommodate the size of the firearm stock 106. As a result, the firearm 107 is cradled and prevented from sliding around while remaining readily accessible to the driver and/or passenger. A user may fasten the strap 114 across the stock 106 of the firearm 107 or couple the cable lock 118 around the receiver or trigger guard of the firearm 107. In some embodiments, a magnet 122 may be coupled to a metal component of the vehicle to further stabilize the firearm holder 100 during use.

As a result, the firearm holder 100, 200 disclosed herein solves the need for a firearm holder that does not require modification to the vehicle, allows the user to adjust their seat, enables quick access to the firearm 107, and accommodates a wide spectrum of makes and models across rifles and shotguns.

It will also be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A firearm holder, comprising:
a leg configured to be interposed between two seats or a seat and a console within a vehicle;
a U-shaped bracket coupled to a top end of the leg, the bracket comprising a first arm and a second arm opposite the first arm.

2. The firearm holder of claim 1, further comprising a strap configured to secure a stock of a firearm within the bracket.

3. The firearm holder of claim 1, wherein the bracket further comprises at least one channel for receiving at least one stock protrusion.

4. The firearm holder of claim 1, wherein the bracket further comprises at least one aperture configured to receive a thumb screw.

5. The firearm holder of claim 1, wherein the leg further comprises a non-abrasive coating configured to prevent aesthetic damages to the vehicle when inserting the leg between the seats or the seat and console.

6. The firearm holder of claim 1, further comprising a cable lock configured to immobilize a receiver or a trigger of a firearm.

7. The firearm holder of claim 1, further comprising a base coupled to a bottom end of the leg.

8. The firearm holder of claim 1, wherein the leg comprises a magnet couplable to metal components on the console or the seats of the vehicle.

9. The firearm holder of claim 1, further comprising a floor barrel bracket configured to receive a barrel.

10. The firearm holder of claim 9, wherein the floor barrel bracket comprises a barrel sleeve.

11. A firearm holder, comprising:
a leg configured to be interposed between two seats or a seat and a console within a vehicle;
a bracket coupled to a top end of the leg, the bracket comprising a U-shaped formfactor for receiving a stock of a firearm, the bracket further comprising a fixed arm and an adjustable arm opposite the fixed arm;
a strap couplable between the fixed arm and the adjustable arm of the bracket and configured to secure the stock of the firearm to the bracket.

12. The firearm holder of claim 11, wherein the leg further comprises a non-abrasive coating configured to prevent aesthetic damage to the vehicle when inserting the leg between the seats or the seat and the console.

13. The firearm holder of claim 11, further comprising a cable lock configured to immobilize the receiver or the trigger of the firearm.

14. The firearm holder of claim 11, further comprising a base coupled to a bottom end of the leg.

15. The firearm holder of claim 11, wherein the leg comprises a magnet couplable to metal components on the console or the seats of the vehicle.

16. The firearm holder of claim 11, further comprising a floor barrel bracket comprising a barrel sleeve.

17. A method of using a firearm holder to hold a firearm, the method comprising:
forcing a leg of the firearm holder between two seats or a seat and a console of a vehicle until the leg reaches the floor or until a desired position is reached for a bracket coupled to a top of the leg; and
placing a stock of the firearm between a first arm and a second arm of the bracket.

18. The method of claim 17, further comprising securing a strap over the stock, the strap coupled to the first arm and second arm of the bracket.

19. The method of claim 17, further comprising coupling one or more protrusions to the stock of the firearm and inserting the one or more protrusions into one or more corresponding channels in the bracket.

20. The method of claim 17, further comprising bolting a base of the firearm holder to a floor of the vehicle.
